(19) United States
(12) Patent Application Publication
(10) Pub. No.: US 2026/0355668 A1
(43) Pub. Date: Nov. 12, 2026

(54) FILTER UNIT

(71) Applicant: MWS Mikrowellen-Systeme Vertriebs GmbH, Leutkirch (DE)

(72) Inventor: Werner Lautenschläger, Heerbrugg (CH)

(21) Appl. No.: 19/103,044

(22) PCT Filed: Aug. 4, 2023
(86) PCT No.: PCT/EP2023/071671

§ 371 Date: Feb. 11, 2025

(30) Foreign Application Priority Data
Aug. 11, 2022 (DE) 20 2022 104 565.8

(51) Int. Cl. B01D 46/24; B01D 39/20; B01D 46/00; B01D 46/52; B01D 53/88

(52) U.S. Cl. CPC B01D 46/24; B01D 39/2027; B01D 46/0002; B01D 46/521; B01D 53/885; B01D 2265/04

(57) ABSTRACT

The invention relates to a filter unit (1) for filtering and treating a gas, such as an exhaust gas for example. The filter unit (1) has: a filter device (2) for filtering a gas, a catalyst (4) for treating the gas filtered by means of the filter device (2), an outlet (6), via which the gas treated by means of the catalyst (4) can be discharged out of the filter unit (1), and a support structure (8), on which the filter device (2) is arranged, wherein the support structure (8) delimits a chamber (81) in which the catalyst (4) is at least partly arranged. The invention additionally relates to a method for filtering and treating a gas by means of the filter unit (1) according to the invention.

The invention relates to a filter unit and to a method of filtering and treating a gas, for example an offgas.

Processes often give rise to by-products that can have an unwanted effect on the environment (man, animals, plants, ecosystems etc.). Particularly in processes in which energy is converted or which relate to manufacture, unwanted by-products (fine dust and/or toxic components such as NOₓ, SO₂, HCl) can be released into the environment via offgases, where they have an adverse effect particularly on the health of living beings, but also the climate.

Efforts are thus being made to reduce the release of harmful, often toxic by-products (pollutants) into the environment in such processes. However, this is not easy since the plants required for the respective process often require extensive retrofitting or even new development for reduction of the release of the pollutants into the environment via offgases. If processes are already equipped with corresponding means of reducing such release of pollutants into the environment, it may be the case that failure of these means leads to complex maintenance and complete interruption of the respective process, which can have considerable economic effects (production outage, interruption of energy conversion etc.).

It is thus an object of the present invention to overcome the abovementioned disadvantages, i.e. to more easily reduce the release of unwanted by-products in industrial or chemical processes in particular.

This object is achieved by the article and the method according to the independent claims. Further developments are subject matter of the dependent claims that refer back to the independent claims.

In a first aspect, the invention relates to a filter unit for filtering and treatment of a gas, for example an offgas. The filter unit has: a filter device for filtering of a gas, a catalyst for treatment of the gas filtered by the filter device, an outlet by means of which the gas treated with the catalyst is removable from the filter unit, and a support structure on which the filter device is disposed, where the support structure bounds a space within which the catalyst is at least partly disposed.

The filter unit thus provides, in a single apparatus, dual cleaning over two stages, namely filtering of the gas via a first stage (i.e. deposition and retention of particular particles, for example fine dust, which are transported via the gas) and, via a second stage, treatment of the gas thus filtered with the catalyst and hence for further reduction of harmful (for example gaseous) media in the gas. It is thus easily possible to equip or retrofit apparatuses or plants, for example energy conversion plants or components (power plants, incineration plants, biogas plants, heating plants using renewable raw materials (for example wood pellets), natural gas plants, chimney stacks etc.) or manufacturing plants (for example for cement production), with the filter unit in order to achieve significant reduction in the harmful media in particular (fine dust, toxic components such as NOₓ, SO₂, HCl etc.) that are released into the environment in the particular process. In particular, two-stage cleaning by the filter unit can clean a gas such that it includes virtually no fine dust particles and toxic components and hence is even cleaner than the ambient air.

Moreover, the at least partial positioning of the catalyst within the space bounded by the support structure and the positioning of the filter device on the support structure results in provision of a very compact filter unit. This makes it possible to provide the filter unit simply at the desired site (for example at an offgas outlet such as a chimney stack). It is also possible to employ the filter unit, by virtue of its compact configuration, even at sites that are difficult to access, by means of which a reduction in the level of particles (especially fine dust) and other harmful components (for example gaseous components) is simplified to an exceptional degree in all processes.

The filter device may be positioned at least partly outside the space bounded by the support structure. This means that maintenance (exchange, cleaning etc.) of the filter device is particularly simple, since, in particular, there is no requirement for access to the space bounded by the support structure in order to maintain the filter device. It is thus also possible for the filter device to be provided in a simple manner in the manufacture of the filter unit, for example in that the filter device is wrapped around the support structure.

The filter device is preferably secured to the support structure. This ensures particularly efficiently that the filter device remains in a defined position relative to the support structure under mechanical stress (for example owing to flow, transport or other effects).

The filter device may be secured to the support structure in a cohesive manner, for example a weld bond (preferably a nanoscale weld bond and/or a sintered weld bond). In this way, it is possible to secure the filter device to the support structure in a particularly simple manner, since such securing can be effected, for example, via contact points between support structure and filter device. Moreover, such a manner of securing can be automated particularly efficiently, which saves time and costs.

The filter device may be in two-dimensional form and/or have one or more layers. The filter device is thus provided in a particularly space-saving manner in the filter unit and is also easily positionable therein. It is also possible to provide different functions (for example filter stages) of the filter device in a simple manner via the multiple layers. It is preferable when a first layer of the filter device has higher filter fineness than a second layer of the filter device, where the first layer is preferably provided downstream of the second layer. In this way, particularly good filtering by the filter device is possible.

The filter device preferably forms a cylindrical and/or tubular shape. This means that the one or more layers possessed by the filter device may form a shape corresponding to a cylinder or tube (for example via positioning on the support structure or wrapping of the support structure).

The filter device may include or consist of a weave, where the weave is preferably a microweave. This results in particularly good filter performance and particularly advantageous suitability for positioning of the filter device on the support structure, which saves space and costs. A filter device may provide particularly advantageous suitability for filtering via a particularly fine-mesh weave (for example a stainless steel composite weave).

The filter device may be designed to separate out particles that each have a diameter in the range from 10 to 100 μm, wherein the diameter is preferably an aerodynamic diameter.

The filter device preferably comprises stainless steel. In this way, the filter device can firstly achieve good filtering and can secondly be positioned easily on the support structure.

Moreover, the stainless steel imparts a more resistant structure to the filter device, by means of which high filter performance in particular is possible over a prolonged period of time. The stainless steel may be provided in the filter device in different ways. It is preferable when the stainless steel forms a stainless steel weave, where the filter device includes or consists of the stainless steel weave.

The space bounded by the support structure may be filled mainly (i.e. to an extent of at least 75%) by the catalyst. In other words, the support structure may be matched mainly to the volume that bounds the catalyst. The filter unit is thus of a particularly compact and space-saving design. It is preferable when the catalyst occupies at least 50%, more preferably at least 90%, of the space bounded by the support structure.

The support structure may fully surround the catalyst. As a result, the catalyst is in a particularly space-saving arrangement within the support structure. The structure may also serve as an envelope for the catalyst and hence protect the catalyst, for example, from external mechanical stress as well (for example impacts).

The support structure may be in elongated and/or tubular form. It is preferable here when the catalyst extends at least partly along the axis of the elongated and/or tubular form of the structure. In this way, it is possible in particular for the gas already filtered by the filter device to flow along a particularly long catalyst pathway. The axis of the elongated and/or tubular form of the support structure preferably extends through the outlet. This means that the filter unit is of a particularly compact design.

It is preferable when the support structure has a width or diameter in the range from 50 to 200 mm, preferably from 70 to 150 mm, more preferably from 90 to 130 mm, where, in one embodiment, the width or diameter of the support structure is, for example, 120 mm. This means that the support structure and the filter device positioned at least partly in the space therein are of a particularly compact design.

The support structure may have multiple passage openings by which the gas, preferably in a state as filtered through the filter device, can enter the space bounded by the support structure. The support structure thus simultaneously provides an inlet via which the gas which is filtered by the filter device and is then to be treated by the catalyst can enter the space bounded by the support structure. The filter unit is thus of a particularly compact design. In particular, the passage openings may be provided such that a gas can flow over the entire circumference of the support structure (i.e. all round) from outside the filter unit into the space bounded by the support structure and hence pass through the filter device.

The support structure may have a sidewall to which the filter device is secured, where the sidewall has at least some of the passage openings. The support structure may optionally have a base from which the sidewall extends. It is thus possible for the space bounded by the support structure to be bounded firstly (laterally) by the sidewall and secondly (at the bottom) by the base, where the insides of these walls are directed toward the filter device. This enables particularly compact positioning of the filter device relative to the support structure. The base may have some (more) of the passage openings. Alternatively, however, it is also possible that the base is designed such that it is impervious to a gas to be treated by the filter unit and/or takes the form of a cap, i.e. in particular has no passage opening. This allows a gas to flow solely laterally into the space bounded by the support structure, namely via the sidewall.

The support structure may comprise a braid (wire braid, rotary braid etc.), a weave and/or a mesh, in order to form at least some of the passage openings. As a result, it is possible to provide the passage openings in a particularly simple manner. In addition, it is conceivable, for example, that the corresponding structures of the support structure (the structures have rods, for example, and preferably run transverse to one another) serve to secure the filter device. If the support structure comprises a braid, the support structure preferably forms a support braid.

Each passage opening may be bounded by an outline, for example a polygonal (especially rectangular) or round (especially elliptical or circular) outline, where the greatest possible distance between two points on the outline (this distance corresponds to the diameter in the case of a circular outline) is in the range from 0.5 to 1.5 mm, preferably from 0.75 to 1.25 mm. If the passage openings are each in circular form, each passage opening may have a diameter in the range from 0.5 to 1.5 mm, preferably from 0.75 to 1.25 mm. By virtue of such distances or diameters, a gas can flow particularly efficiently through and be filtered by the support structure and hence the filter device positioned on the support structure.

The support structure may have been manufactured from metal. In this way, the support structure may be manufactured in a simple manner and provide particularly good stiffness, as a result of which the filter unit is robust particularly against external effects (percussion, impacts etc.).

The filter unit may also have an outlet conduit having the outlet. The outlet may thus be provided and maintained in a particularly simple manner. It is also possible in a simple manner with the outlet conduit to connect the outlet to further conduits or the environment (namely in that the outlet then projects into the environment). It is preferable when the outlet conduit is an outlet tube.

The outlet conduit may have a flange via which the outlet conduit is secured to the support structure, especially to an edge of the support structure. In this way, the outlet conduit may be easily provided in the filter unit, namely by positioning the flange merely on the structure and then securing it thereto. The flange is preferably provided such that it (at least partly) bounds the space bounded by the support structure. In this way, it is possible to further reduce the size of the filter unit. Alternatively or additionally, the sidewall (or the aforementioned edge) of the support structure may define an opening covered at least partly by the flange. If the outlet conduit along with the flange is secured on the support structure, the opening is preferably covered by the flange apart from the place where the gas treated with the catalyst flows out of the space via the opening into the outlet or outlet conduit.

The outlet conduit, preferably the flange, may be secured on the support structure via a form-and/or force-fitting connection. In this way, it is easily possible to disassemble the filter unit, for example by parting the form-and/or force-fitting bond with or without a tool, after which it is then possible, for example, to remove or pull the catalyst out of the space bounding the support structure. Such a connection between outlet conduit and support structure enables maintenance of the filter unit without complete stoppage of operation, which means that, for example, access to the support structure space is possible, while filtering and treatment of the gas is still possible through the filter device and the catalyst. The form-and/or force-fitting connection preferably has a screw connection. Parting of the force-and/or form-fitting connection can also have the effect that a component of the filter unit (support structure, catalyst, filter device etc.) can easily be exchanged as such.

The catalyst may have a preferably cylindrical or sleeve-shaped housing. In this way, the catalyst may be provided in the form of a cartridge (“catalyst cartridge”). A catalyst filling may be positioned in the housing, where the catalyst filling preferably comprises a granular material and/or is at least partly provided in bead form.

The housing of the catalyst may have a catalyst base and a catalyst sidewall that extends away from the catalyst base. The catalyst base and the catalyst sidewall thus preferably bound a space in which the catalyst filling is positioned. It is preferable when the gas (as filtered by the filter device) is suppliable to the catalyst for treatment via the catalyst base. It is thus possible to ensure in a particularly simple manner that the gas to be treated passes through and is treated by the catalyst over its entire length. In a preferred embodiment, the gas is preferably suppliable to the catalyst solely via the catalyst base.

The catalyst sidewall may run alongside and/or parallel to a wall (for example the sidewall) of the support structure. As a result, the catalyst is in a particularly space-saving arrangement relative to the support structure, which allows the filter unit to be further reduced in size. Alternatively or additionally, the catalyst base may run alongside and/or parallel to a (further) wall (for example the base) of the support structure. This likewise results in a particularly space-saving arrangement of the support structure and of the catalyst relative to one another.

The filter unit may also have a further filter device, for example a molecular sieve. The use of the further filter device means that (unwanted) gases (for example CO2 or hydrofluoric acid vapors that arise in the combustion of plastics such as PTFE and derivatives thereof) can also be removed from the gas or gas mixture, which means that the gas released from the filter unit via the outlet is particularly clean. This means that the filter unit can be used, for example, in a ventilator. The further filter device may be provided downstream of the filter device and upstream of the catalyst or within the catalyst and/or positioned in the space bounded by the support structure. The further filter device is thus in a particularly compact arrangement in the filter unit.

In a second aspect, the invention relates to a method of filtering and treating a gas, for example an offgas. The method has the following (successive) steps: providing a filter unit as described above; filtering the gas through the filter device of the filter unit; treating the filtered gas by means of the catalyst of the filter unit; and removing the filtered and treated gas from the filter unit via the outlet of the filter unit.

The invention will be described by way of example below by means of the figures showing a preferred embodiment of the invention. The figures show:

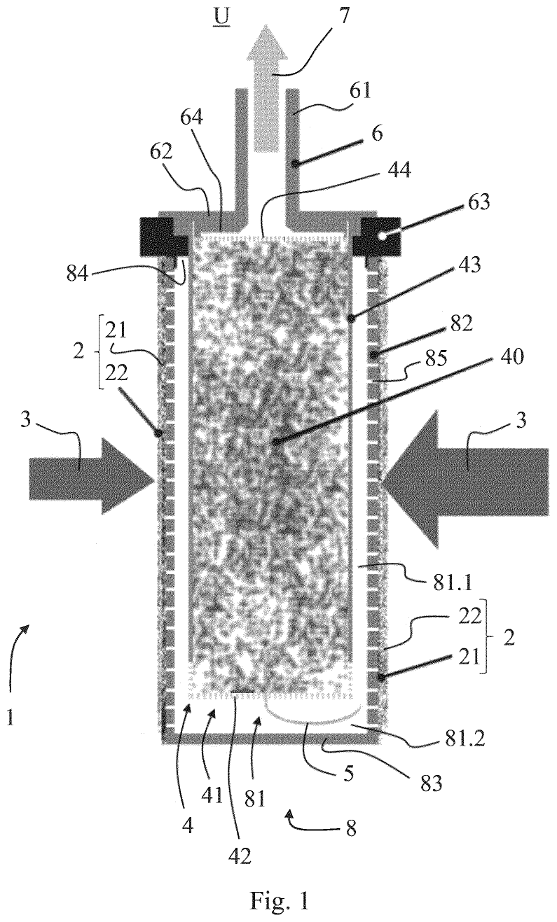

FIG. 1a schematic section view of a preferred embodiment of the filter unit of the invention; and

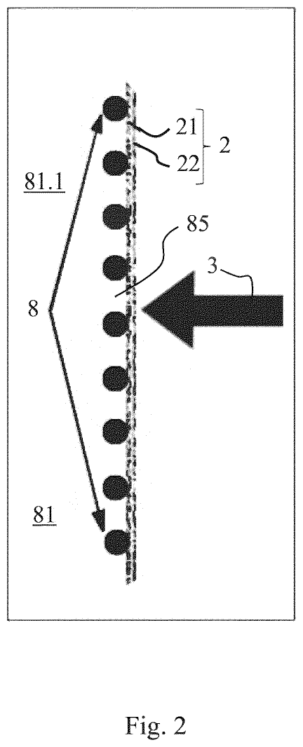

FIG. 2 an enlarged detail of the filter unit shown in FIG. 1, where the detail shows a sidewall of the support structure with the filter device positioned on the sidewall.

FIG. 1 shows a filter unit 1 according to a preferred embodiment. The filter unit 1 is intended first to filter and then to treat a gas. The gas is formed, for example, as a by-product in a process which is, for example, an energy conversion process and/or a manufacturing process. In particular, the gas may be an offgas, smoke and/or air. The gas may in particular include (harmful) media (particles, gases etc.), which are to be removed from the gas or at least rendered harmless by the filter unit 1.

The filter unit 1 has a filter device 2. The filter device 2 is intended to filter the gas, the flow of which is indicated by the arrows 3 in FIG. 1. The filter device 2 is designed in particular to retain particles of a particular size, such that the gas flowing out of the filter device 2 includes fewer particles, for example fine dust, compared to the gas flowing into the filter device 2. It is preferable when the filter device 2 is designed to separate out particles that each have a diameter in the range from 10 to 100 μm; this diameter is preferably an aerodynamic diameter. The particles filtered out of the gas then accumulate on and/or in the filter 2, where they can then be removed.

The filter device 2 is not limited to a specific configuration. The filter device 2 is preferably in two-dimensional form. What this means is more particularly that the filter device 2 may have a constant thickness in the direction over which it extends to form the two-dimensional shape. FIG. 2 shows, by way of example, a preferred configuration of the filter device 2 in enlarged form. It is apparent that the filter device 2 may have or consist of multiple, in particular two, layers 21, 22. Multiple layers or a multilayer structure of the filter device 2 are advantageous especially in order to achieve a high filter performance. The layers 21, 22 may have different filter fineness. The first layer 21 may be provided downstream of the second layer 22 and also have higher filter fineness than the second layer 22. This achieves particularly high filter performance of the filter device 2. The first layer 21 may be a microweave layer, for example having a mesh size of 10 to 200 μm, preferably of 10 to 100 μm, more preferably of 25 to 50 μm. The second layer 22 may be a coarser deposition braid and/or have a coarser mesh size, preferably such that at least fine dust particles can be deposited.

The filter device 2, especially the layers 21, 22 thereof, may have or consist of a weave. It is preferable when the layers 21, 22 each consist of a weave. The weave may be a microweave. The microweave preferably forms passage openings having a diameter of in each case 10 to 100 μm, preferably 25 to 50 μm. The filter device 2 is not limited to a particular material. The filter device 2 may have been manufactured from one material or from different materials. The filter device 2 preferably comprises stainless steel.

The filter unit 1 also has a catalyst 4. In relation to the gas flow that passes through the filter unit 1 for filtering and treatment, the catalyst 4 is disposed downstream of the filter device 2. In this way, the catalyst 4 can be used to treat the gas filtered with the filter device 2 (i.e. the gas flowing out of the filter device 2). FIG. 1 indicates the gas flowing out of the filter device 2 and then flowing into the catalyst 4 by the arrow 5. The catalyst 4 treats the gas in that the catalyst 4 converts particular media present in the gas to be treated (for example gaseous media) in such a way that they are harmless to the environment (living organisms, plants, ecosystems etc.), in particular nontoxic. If the gas filtered through the filter device 2, for example, still contains the gaseous product NOₓ, the catalyst 4 will convert this NOₓ to nontoxic nitrogen (N₂). The catalyst 4 consequently results in catalytic or adsorptive purification of the gas.

The catalyst 4 may have a preferably cylindrical or sleeve-shaped housing 41 in which a catalyst filling 40 is preferably provided. The housing 41 has preferably been manufactured from steel and/or another high-grade resistant material. The catalyst filling 40 is designed to convert the harmful media provided in the gas to be treated (pollutants, for example combustion pollutants) by chemical conversion to nontoxic substances (for example CO₂, H₂O and N₂). Such a conversion can be effected, for example, by oxidation or reduction. The catalyst filling 40 is preferably provided in the form of a granular material and/or in the form of beads. In addition, the catalyst 4 may be set up to neutralize gases (HCl, SO₂ etc.) (for example in salt form) and retain them. The gases thus neutralized are then retained in the catalyst 4, for example, in the form of a salt or another, preferably solid substance, as a result of which they cannot escape into the environment. The catalyst 4 thus forms what is called a “chemical sponge”.

The housing 41 may have a catalyst base 42 which is preferably in the form of a dish. The gas preferably enters the catalyst 4 via the catalyst base 42, in order to correspondingly treat this gas in the catalyst 4. For this purpose, the catalyst base 42 may be formed with multiple passage openings and/or as a sieve plate. The catalyst base 42 may thus be perforated. It may especially be the case, for advantageous entry of the gas to be treated into the catalyst 4, that the catalyst base 42 is provided in the form of a mesh (especially a coarse mesh). The housing 41 preferably has a sidewall 43 that extends away from the catalyst base 42. There is preferably no entry of gas into the catalyst 4 via the sidewall 43, such that gas can preferably only enter the catalyst 4 via the catalyst base 42. The sidewall 43 preferably completely surrounds the catalyst filling 40. For example, the sidewall 43 may form a cylinder or tube.

The housing 41 may also have an upper portion 44 via which the gas treated with the catalyst can escape from the catalyst 4. The upper portion 44 is preferably connected to the catalyst base 42 via the sidewall 43. The upper portion 44 preferably has multiple passage openings via which the treated gas can flow out of the catalyst 4. It is preferable when the catalyst filling 40 extends between catalyst base 42 and upper portion 44 and/or preferably completely fills a space defined between these portions 42, 44. The catalyst base 42, the sidewall 43 and the upper portion 44 preferably bound a space in which the catalyst filling 40 is provided.

The filter unit 1 also has an outlet 6 by means of which the gas treated with the catalyst 4 is removable from the filter unit 1. The stream of the both filtered and treated (and hence particularly clean) gas exiting from the outlet 6 and hence from the filter unit 1 into the environment U is indicated in FIG. 1 by the arrow 7. The outlet 6 is preferably provided such that the gas flowing out of the upper portion 44 and treated by the catalyst 4 can directly or indirectly enter the outlet 6. Indirect entry is possible, for example, in that the gas flowing out of the upper portion 44 enters the outlet 6 via an interspace formed between upper portion 44 and outlet 6. It is preferable when the direction of flow of the gas flowing out of the upper portion 44 is at least partly parallel to the direction of flow of the gas flowing out of the outlet 6 (see arrow 7). As a result, catalyst 4 and outlet 6 are in a particularly space-saving arrangement relative to one another.

The filter unit 1 may have an outlet conduit 61 having the outlet 6. The outlet conduit 61 may serve as a terminal for connection to a further conduit or project into the environment U. The outlet conduit 61 may have a securing region to which the further conduit may be secured. The outlet conduit 61 may be designed such that it establishes a defined direction of flow of the gas exiting from the outlet 6 and hence from the filter unit 1. The outlet conduit 61 is preferably an outlet tube.

The filter unit 1 also has a support structure (i.e. a carrier structure) 8 on which at least the filter device 2 is disposed. The support structure 8 thus at least holds the filter device 2, such that the filter device 2 especially has a defined position relative to the support structure 8 and hence to the catalyst 4. In particular, the filter device 2 is held captively by means of the support structure 8, such that, in particular, undisrupted operation of the filter device 2 is possible within the filter unit 1. The filter device 2 is preferably secured on the support structure 8, for example via cohesion. Cohesive securing can be effected by means of a weld bond, preferably over several points and/or lines. The weld bond may be a nanoscale weld bond. In other embodiments, the filter device 2 may also be force-and/or form-fittingly secured to the support structure 8.

The support structure 8 defines or bounds a space 81 in which the catalyst 4 is at least partly positioned. As a result, the catalyst 4 is integrated within the filter unit 1 and hence in a particularly space-saving arrangement. The support structure 8 may have a sidewall 82 on which the filter device 2 is secured and which laterally bounds the space 81. The support structure 8 may also have a base 83 from which the sidewall 82 extends. The base 83 bounds the space 81, preferably from the bottom, meaning that the space 81 preferably extends between the base 83 and the outlet 6. The sidewall 82 preferably defines an opening 84 via which the space 81 can be accessed. For example, the catalyst 4 may be positioned at least partly in the space 81 via the opening 84. In an installed state of the catalyst 4, the catalyst 4 may extend through the opening 84 and hence be seen to project beyond the sidewall 82. A portion of the catalyst 4, namely the portion protruding from the opening 84, may thus be provided outside the space 81, whereas the remaining portion of the catalyst 4 is positioned completely within the space 81. Alternatively, it may also be possible for the catalyst 4 to be positioned entirely—i.e. completely-within the space 81.

The support structure 8 preferably completely surrounds the catalyst 4. For this purpose, the structure 8 may at least partly take the form of a tube and/or the sidewall 82 may completely surround the catalyst 4 (viewed in a section view). As apparent in FIG. 1, the support structure 8 may be elongated and hence form a correspondingly elongated space 81 in which the catalyst 4 may have a correspondingly elongated extent. The structure 8 may have a round (circular, elliptical etc.) or polygonal (quadrangular, rectangular, square etc.) cross section. The width or diameter of the support structure 8 may be within a range from 50 to 200 mm, preferably from 70 to 150 mm, more preferably from 90 to 130 mm. In a particularly preferred embodiment, the support structure 8 has a width or diameter of 120 mm +/−10 mm.

The catalyst 4 may be positioned within the space 81 such that the catalyst 4 (i.e., in particular, the volume defined by the catalyst housing 41) fills most of the space 81, preferably at least to an extent of 75%, more preferably to an extent of at least 90%. If the catalyst 4 is positioned at least partly in the space 81, an interspace 81.1, 81.2 may be formed between catalyst 4 and support structure 8. The interspace may have a first interspace 81.1 and a second interspace 81.2. The first interspace 81.1 may be annular, for example in the form of a ring having a polygonal or round (preferably circular) shape. The first interspace 81.1 is bounded laterally preferably at least by the sidewall 43 (and preferably by a lateral portion of the base 42) of the catalyst 4 and the sidewall 82 of the support structure 8. The second interspace 81.2 may have a shape that does not correspond to a ring. The interspace 81.2 preferably extends between the base 42 of the catalyst 4 and the base 83 of the structure 8. In other words, the interspace 81.2 may be bounded at the top by the base 42 and at the bottom by the base 83. The interspaces 81.1, 81.2 are preferably fluidically interconnected.

As apparent in FIG. 1, the catalyst sidewall 43 may run alongside and parallel to the sidewall 82 of the support structure 8 in order thus preferably to form the interspace 81.1.

Alternatively, however, it may also be the case that the interspace 81.1 is formed in that the catalyst sidewall 43 does run alongside the sidewall 82, but does not run parallel and instead runs obliquely thereto, for example. As likewise apparent in FIG. 1, the catalyst base 42 may run alongside and parallel to the base 83 of the support structure 8 in order preferably to form the interspace 81.2. However, the interspace 81.2 may also be formed in that the catalyst base 42 does run alongside the base 83, but does not run parallel and instead runs obliquely thereto, for example.

The outlet conduit 61 having the outlet 6 may have a flange 62 by which the outlet conduit 61 and hence the outlet 6 is secured to the support structure 8. The securing is preferably effected by means of a form-and/or force-fitting connection, for example a screw connection or a quick-release connection. The securing is preferably effected via a securing means 63 that preferably provides the form-and/or force-fitting connection between flange 62 and support structure 8, for example the sidewall 82 (especially the free end of the sidewall 82 that defines the opening 84). The securing means 63 is preferably set up to secure the flange 62 to the support structure 8 with a tool (screwdriver etc.) or without a tool (for example in that the securing means 63 has a lever for elective parting or provision of the connection to the support structure 8). The securing means 63 preferably has: a first region where the flange 62 is provided (preferably in a partable manner, for example via a force fit and/or form fit, especially via a screw connection), and a second region where the support structure 8 is provided in the form of its sidewall 82 (preferably in an inextricable manner, for example via a cohesive bond, especially via a weld bond). The securing means 63 may have a region where the catalyst 4, preferably the sidewall 43 thereof, is disposed and preferably secured, especially via a force fit, form fit and/or cohesive bond. This region may have a region directed inward (i.e., for example, in the direction of the longitudinal axis of the catalyst 4).

The flange 62 is preferably provided such that it bounds the space 81, preferably at an upper end of the support structure 8, and/or partly covers the opening 84, such that exit from the opening 84 into the environment U is possible only via the outlet 6. The flange 62 preferably has, on its side (inside) 64 directed toward the space 81, a region where the catalyst 4 (preferably in the form of its sidewall 43) may be provided and, for example, also secured, especially via a force fit, form fit and/or cohesive bond. In particular, the catalyst 4 may be inserted into the side 64. Alternatively or additionally, the catalyst 4 (for example in the form of its sidewall 43) may be provided and preferably secured on the securing means 63, especially via a force fit, form fit and/or cohesive bond. By parting and then removing the flange 62 from the support structure 8, it may be possible in particular for the catalyst 4 to be removed simultaneously from the space 81. It may alternatively, however, also be the case that detachment of the flange 62 leaves the catalyst 4 still secured with regard to the support structure 8 (for example via the securing means 63), in order hence to conduct, for example, maintenance (repair, removal etc.) on the catalyst 4.

It is preferable when the filter device 2 is disposed outside the space 81 bounded by the support structure 8, as shown by way of example in FIGS. 1 and 2. As a result, the filter device 2 can be easily maintained (cleaned, exchanged etc.) without disassembling the filter unit 1, meaning in particular that the outlet 6 and/or catalyst 4 have to be moved relative to the support structure 8 in order to obtain access to the filter device 2. In addition, it is thus possible for the filter device 2 to be provided in a simple manner in a manufacturing process, for example in that the filter device 2 is wrapped around the support structure 8.

The gas that flows out of the filter device 2 and has thus been filtered can flow in the direction of the catalyst 4 provided downstream in different ways. One means of this is shown in FIGS. 1 and 2. It is apparent that the support structure 8 has multiple passage openings 85 by which the gas in a state as filtered through the filter device 2 can enter the space 81 bounded by the support structure 8. The passage openings 85 are preferably provided such that they open into the first interspace 81.1 and/or the second interspace 81.2. The sidewall 82 may have the passage openings 85, for example in that the latter are distributed uniformly over the area (preferably the whole area) of the sidewall 82. The base 83 preferably does not have any passage openings 85 and hence is impermeable to a gas and/or takes the form of a cap. In other embodiments, the base 83 may also have some of the passage openings 85. In that case, the filter device 2 is preferably also positioned on the base 83 and preferably secured thereto.

The passage openings 85 may be provided in different ways. As shown in FIGS. 1 and 2, the support structure 8 may, for example, have a braid, a weave and/or a mesh (grid) in order to form at least some of the passage openings 85. It may be the case that the sidewall 82 forms the braid, weave and/or mesh. As shown in FIG. 2, the structures that form the braid, weave and/or mesh—i.e. (linear) structures in particular that run transverse to one another-may have regions to which the filter device 2 is secured. For example, it is conceivable that these structures have the linear or point contact regions between support structure 8 and filter device 2 via which the filter device 2 is cohesively secured to the support structure 8.

The passage openings 85 preferably each have a defined size. For example, the greatest possible distance between two points on a (polygonal, circular etc.) outline bounding a passage opening 85 is in the range from 0.5 to 1.5 mm, preferably from 0.75 to 1.25 mm. If the passage openings 85 are each in circular form, the diameter of each is preferably within a range from 0.5 to 1.5 mm, preferably from 0.75 to 1.25 mm.

The support structure 8 is not limited to a particular material. The support structure 8 may have been manufactured solely from one material or from different materials. The support structure 8 has preferably been manufactured from metal. The support structure 8 may be manufactured, for example, by securing the base 83 to the sidewall 82 by cohesive bonding, for example a weld bond.

The filter unit 1 may also have a further filter device (not shown), for example a molecular sieve, which is preferably provided downstream of the filter device 2 and upstream of the catalyst 4, for example in the space 81, or in the catalyst 4, for example in the space for the catalyst filling 40. Alternatively, however, it may also be the case that the further filter device is provided downstream of the catalyst 4. The gas flowing out of the outlet 6 is thus firstly filtered through the filter device 2 and treated by the catalyst 4, and secondly further filtered through the further filter device. In the filter stage provided by the further filter device, for example, particular gases (e.g. CO₂) may be filtered.

The embodiment of the filter unit 1 as shown in FIGS. 1 and 2 can be used to filter and treat a gas (for example an offgas) as follows. A gas firstly enters the filter device 2 (see arrows 3), where it is filtered, and hence particular particles (fine dust etc.) are separated out of the gas and retained (“sieve effect”). Subsequently, in the filtered and hence precleaned state—in this state the gas may still include gaseous products such as nitrogen (N₂)—the gas enters the interspace 81.1 and/or interspace 81.2 via the passage openings 85. The gas entering the interspace 81.1 then flows along the sidewalls 43, 82 in the direction of the catalyst inlet or catalyst base 42, where it enters the catalyst 4 for treatment. The filtered gas that enters the interspace 81.2 directly via the passage openings 85 can enter the catalyst 4 directly, namely solely via a route that runs through the interspace 81.2. Having entered the catalyst 4, the gas passes through the catalyst 4 preferably over its entire length, in order thus to be treated by means of a maximum surface area, i.e. to very substantially convert particular media (pollutants such as NOx) in the gas filtered by the filter device 2. Subsequently, the treated gas flows out of the catalyst 4, for example via the upper portion 44, and enters the environment U via the outlet 6. The gas at that point has then been both filtered and treated, and hence constitutes no risk, or at least a considerably reduced risk, to the environment U.

The filter device 2 can be cleaned by increasing the pressure in the space 81. The resultant positive pressure results in pressure equalization via the filter device 2 between the space 81 and the exterior alongside the filter device 2, as a result of which the particles collected in the filter device 2 can be removed from the filter device 2. The pressure in the space 81 is preferably increased via the outlet 6 or an inlet (not shown; for example, the flange 62 has the inlet), for example in that a fluid (ambient air etc.) is supplied to the space 81. In one embodiment, the filter unit 1 has a flow unit in order to supply the fluid to the space 81 and hence to increase the pressure therein.

The invention is not limited to the features described above; in particular, the features described above can be combined with one another in any desired manner.

1. A filter unit (1) for filtering and treatment of a gas, for example an offgas, having:
a filter device (2) for filtering of a gas,
a catalyst (4) for treatment of the gas filtered by the filter device (2), an outlet (6) by means of which the gas treated with the catalyst (4) is removable from the filter unit (1), and
a support structure (8) on which the filter device (2) is disposed, where the support structure (8) bounds a space (81) within which the catalyst (4) is at least partly disposed.

2. The filter unit (1) as claimed in claim 1, wherein the filter device (2) is disposed at least partly outside the space (81) bounded by the support structure (8).

3. The filter unit (1) as claimed in claim 1, wherein the filter device (2) is secured on the support structure (8).

4. The filter unit (1) as claimed in claim 1, wherein the filter device (2) is cohesively secured, for example via a weld bond, on the support structure (8).

5. The filter unit (1) as claimed in claim 1, wherein the filter device (2) is in two-dimensional form and/or has one or more layers (21, 22), wherein a first layer (21) preferably has a higher filter fineness than a second layer (22), wherein the first layer (21) is preferably disposed downstream of the second layer (22).

6. The filter unit (1) as claimed in claim 1, wherein the filter device (2) forms a cylindrical and/or tubular shape.

7. The filter unit (1) as claimed in claim 1, wherein the filter device (2) includes or consists of a weave, wherein the weave is preferably a microweave.

8. The filter unit (1) as claimed in claim 1, wherein the filter device (2) is designed to separate out particles that each have a diameter in the range from 10 to 100 um, wherein the diameter is preferably an aerodynamic diameter.

9. The filter unit (1) as claimed in claim 1, wherein the filter device (2) comprises stainless steel.

10. The filter unit (1) as claimed in claim 1, wherein the space (81) bounded by the support structure (8) is mainly filled by the catalyst (4), wherein the catalyst (4) preferably occupies at least 75%, more preferably at least 90%, of the space (81) bounded by the support structure (8).

11. The filter unit (1) as claimed in claim 1, wherein the support structure (8) fully surrounds the catalyst (4).

12. The filter unit (1) as claimed in claim 1, wherein the support structure (8) is in elongated and/or tubular form.

13. The filter unit (1) as claimed in claim 1, wherein the support structure (8) has a width or diameter in the range from 50 to 200 mm, preferably from 70 to 150 mm, more preferably from 90 to 130 mm, wherein the width or diameter of the support structure (8) is, for example, 120 mm.

14. The filter unit (1) as claimed in claim 1, wherein the support structure (8) has multiple passage openings (85) by which the gas, preferably in a state as filtered through the filter device (2), can enter the space (81) bounded by the support structure (8).

15. The filter unit (1) as claimed in claim 14, wherein the support structure (8) has a sidewall (82) on which the filter device (2) is secured, wherein the sidewall (82) has at least some of the passage openings (85), wherein the support structure (8) preferably has a base (83) from which the sidewall (82) extends, wherein the base (83) preferably has some of the passage openings (85) or is impermeable to a gas to be treated by the filter unit (1) and/or takes the form of a cap.

16. The filter unit (1) as claimed in claim 14, wherein the support structure (8) has a braid, a weave and/or a mesh in order to form at least some of the passage openings (85).

17. The filter unit (1) as claimed in claim 14, wherein each passage opening (85) is bounded by an outline, for example a polygonal or round outline, wherein the greatest possible distance between two points on the outline is in the range from 0.5 to 1.5 mm, preferably from 0.75 to 1.25 mm, or wherein each passage opening (85) has a diameter in the range from 0.5 to 1.5 mm, preferably from 0.75 to 1.25 mm.

18. The filter unit (1) as claimed in claim 1, wherein the support structure (8) has been produced from metal.

19. The filter unit (1) as claimed in claim 1, further comprising an outlet conduit (61) having the outlet (6), wherein the outlet conduit (61) is preferably an outlet tube.

20. The filter unit (1) as claimed in claim 19, wherein the outlet conduit (61) has a flange (62) via which the outlet conduit (61) is secured to the support structure (8), wherein the flange (62) preferably bounds the space (81) bounded by the support structure (8), and/or wherein the sidewall (82) of the support structure (8) preferably defines an opening (84) at least partly covered by the flange (62).

21. The filter unit (1) as claimed in claim 19, wherein the outlet conduit (61), preferably the flange (62), is secured via a form-and/or force-fitting connection to the support structure (8), wherein the form-and/or force-fitting connection preferably has a screw connection.

22. The filter unit (1) as claimed in claim 1, wherein the catalyst (4) has a preferably cylindrical or sleeve-shaped housing (41), and wherein the catalyst (4) preferably has a catalyst filling (40) disposed in the housing (41), wherein the catalyst filling (40) preferably comprises a granular material and/or is at least partly in bead form.

23. The filter unit (1) as claimed in claim 22, wherein the housing (41) has a catalyst base (42) and a catalyst sidewall (43) that extends from the catalyst base (42), wherein the gas is preferably suppliable to the catalyst (4) for treatment via the catalyst base (42).

24. The filter unit (1) as claimed in claim 23, wherein the catalyst sidewall (43) runs alongside and/or parallel to a wall of the support structure (8) wherein the wall is, for example, the sidewall (82) of the support structure (8), and/or wherein the catalyst base (42) runs alongside and/or parallel to a further wall of the support structure (8), wherein the further wall is, for example, the base (83) of the support structure.

25. The filter unit (1) as claimed in claim 1, further comprising a further filter device, for example a molecular sieve, wherein the further filter device is preferably provided downstream of the filter device (2) and upstream of the catalyst (4) or within the catalyst (4) and/or disposed in the space (81) bounded by the support structure (8).

26. A method of filtering and treating a gas, for example an offgas, having the following steps:
providing a filter unit (1) as claimed in any of the preceding claims,
filtering the gas through the filter device (2) of the filter unit (1),
treating the filtered gas by means of the catalyst (4) of the filter unit (1) and
removing the filtered and treated gas from the filter unit (1) via the outlet (6) of the filter unit (1).
